(19) United States
(12) Patent Application Publication
(10) Pub. No.: US 2010/0167250 A1
(43) Pub. Date: Jul. 1, 2010

(54) Surgical training simulator having multiple tracking systems

(75) Inventors: Donncha Ryan, Dublin (IE); Derek Cassidy, Kilmanhim (IE)

Correspondence Address: FINNEGAN, HENDERSON, FARABOW, GARRETT & DUNNER;LLP, 901 NEW YORK AVENUE, NW, WASHINGTON, DC, 20001-4413, US

(73) Assignee: Haptica Ltd.

(21) Appl. No.: 12/318,602

(22) Filed: Dec. 31, 2008

(51) Int. Cl. G09B 23/30

(52) U.S. Cl. 434/267

(57) ABSTRACT

A surgical training device, includes a body form, at least two cameras configured to obtain image data of at least one implement located within the body form, and a magnetic tracking system operative to transmit signals, the signals corresponding to position and alignment information of the at least one implement. The surgical training device also includes a computer configured to receive the image data from the at least two cameras, receive the signals from the magnetic tracking system, and generate position and alignment data of the at least one implement from the image data and the signals. A display is operatively coupled to the computer and operative to display at least one image of the at least one implement and a virtual background, the virtual background depicting a portion of a body cavity.

### TECHNICAL FIELD

The present disclosure relates to a surgical training simulator and, more particularly, to a method and apparatus for the training of surgical procedures.

### BACKGROUND

The rapid pace of recent health care advancements offers tremendous promise for those with medical conditions previously requiring traditional surgical procedures. Specifically, many procedures routinely done in the past as “open” surgeries can now be carried out far less invasively, often on an outpatient basis. In many cases, exploratory surgeries have been completely replaced by these less invasive surgical techniques. However, the very reduction to the patient in bodily trauma, time spent in the hospital, and post-operative recovery using a less invasive technique may be matched or exceeded by the technique's increased complexity for the surgeon. Consequently, enhanced surgical training for these techniques is of paramount importance to meet the demands for what have readily become the procedures of choice for the medical profession.

In traditional open surgeries, the operator has a substantially full view of the surgical site. This is rarely so with less invasive techniques, in which the surgeon is working in a much more confined space through a smaller incision and cannot directly see the area of operation. To successfully perform a less invasive surgery involves not only increased skill but unique surgical equipment. In addition to specially tailored instruments, such a procedure typically requires an endoscope, a device that can be inserted in either a natural opening or a small incision in the body. Endoscopes are typically tubular in structure and provide light to and visualization of an interior body area through use of a camera system. In use, the surgeon or an endoscope operator positions the endoscope according to the visualization needs of the operating surgeon. Often, this is done in the context of abdominal surgery. In such an abdominal procedure, a specific type of endoscope, called a laparoscope, is used to visualize the stomach, liver, intestines, and other abdominal organs.

While traditional surgical training relied heavily on the use of cadavers, surgical training simulators have gained widespread use as a viable alternative. Due to the availability of increasingly sophisticated computer technology, these simulators more effectively assess training progress and significantly increase the amount of repetitive training possible. Such simulators may be used for a variety of surgical training situations depending on the type of training desired.

To provide the most realistic training possible, a surgical training simulator for such an abdominal procedure includes a replication of a body torso, an area on the replication specifically constructed for instrument insertion, and proper display and tracking of the instruments for training purposes. Because these simulators do not contain actual abdominal organs, the most advanced among them track the movement of the instruments and combine that with a virtual reality environment, providing a more realistic surgical setting to enhance the training experience. Virtual reality systems provide the trainee with a graphical representation of an abdominal cavity on the display, giving the illusion that the trainee is actually working within an abdominal cavity. For example, U.S. Patent Application Publication 2005/0084833 (the '833 publication), to Lacey et al., discloses a surgical training simulator used for laparoscopic surgery. The simulator has a body form including a skin-like panel for insertion of the instruments, and cameras within to capture video images of the instruments as they move. The cameras are connected to a computer that includes a motion analysis engine for processing these camera images using stereo triangulation to provide 3D position and alignment data. This optical tracking method allows the trainee to practice with actual and unconstrained surgical instruments. A graphics engine in the computer is capable of rendering a virtual abdominal environment as well as a virtual model of the instrument. When the rendered instrument is moved within the virtual environment, the graphics engine distorts the surface area of the rendered abdominal organs affected, displaying this motion on the computer display screen. Such movements may correspond to incising, cauterizing, suturing, or other surgical techniques, therefore presenting a realistic surgical environment not otherwise obtainable without the use of an actual body. The cameras of the '833 publication may also provide direct images of the moving instrument through the computer and combine those images of the live instrument with the rendered abdominal environment, producing an “augmented” reality. This augmented reality further improves the training effect.

While optical tracking methods, such as those utilized in the '833 publication, provide generally accurate positional tracking of instruments, a single tracking method may suffer from inherent errors or inefficiencies in measurement that may be reduced through combination with one or more additional tracking methods. It may therefore be desired to more precisely track with six degrees of freedom the movement of one or more laparoscopic instruments within the body form to enhance the replications of instrument movement available to the surgical trainee, thereby improving the value of the training received.

The present disclosure is directed to overcoming one or more of the shortcomings set forth above and/or other shortcomings in existing technology.

### SUMMARY

A surgical training device, includes a body form, at least two cameras configured to obtain image data of at least one implement located within the body form, and a magnetic tracking system operative to transmit signals, the signals corresponding to position and alignment information of the at least one implement. The surgical training device also includes a computer configured to receive the image data from the at least two cameras, receive the signals from the magnetic tracking system, and generate position and alignment data of the at least one implement from the image data and the signals. A display is operatively coupled to the computer and operative to display at least one image of the at least one implement and a virtual background, the virtual background depicting a portion of a body cavity.

A method of surgical training includes optically tracking at least one implement located within a body form, and magnetically tracking the at least one implement. The method further includes generating position and alignment data of the at least one implement from the optical tracking and the magnetic tracking and displaying at least one image of the at least one implement and a virtual background, the virtual background depicting a portion of a body cavity.

A method of surgical training includes optically tracking at least one implement located within a body form, generating a first set of position and alignment data of the at least one implement using stereo triangulation techniques, and magnetically tracking the at least one implement, the magnetic tracking generating a second set of position and alignment data of the at least one implement. The method further includes comparing the first set of position and alignment data with the second set of position and alignment data and generating a third set of position and alignment data, comparing the third set of position and alignment data with at least one digitally stored model of an implement, generating a set of three dimensional data fields, and displaying at least one image of the at least one implement and a virtual background, the virtual background depicting a portion of a body cavity.

### BRIEF DESCRIPTION OF THE DRAWINGS

FIG. 1 is a perspective view of a surgical training simulator in accordance with the present disclosure;

FIG. 2 is a lengthwise cross sectional view of a body form of the surgical training simulator;

FIG. 3 is a plan view of a body form of the surgical training simulator;

FIG. 4 is a block diagram showing selected inputs and outputs of a computer of the surgical training simulator;

FIG. 4a is a flow diagram showing selected steps performed within a motion analysis engine of the surgical training simulator; and

FIGS. 5 to 9 are flow diagrams illustrating processing operations of the surgical training simulator.

### DETAILED DESCRIPTION

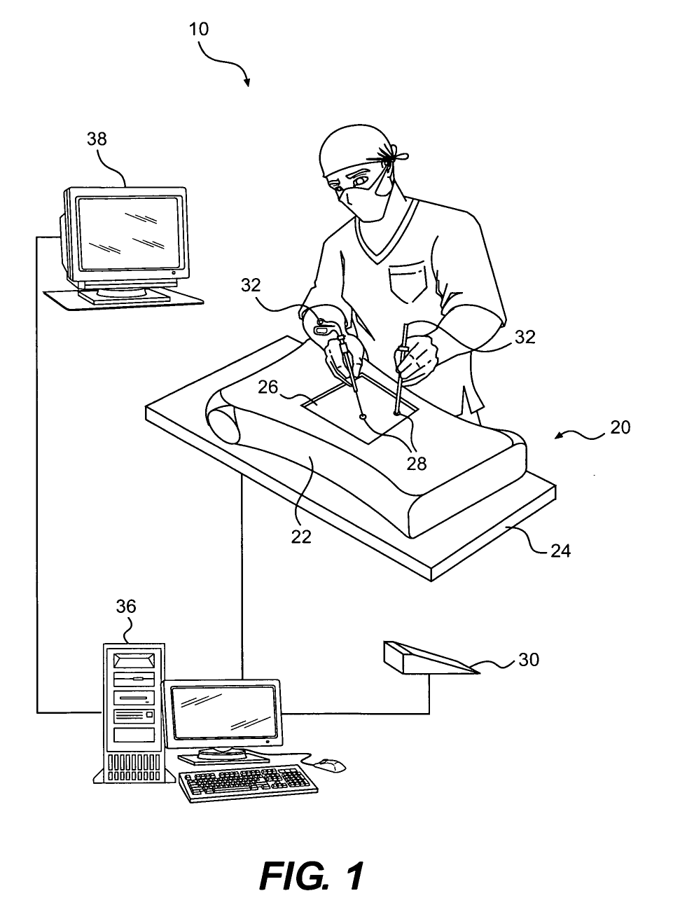

FIG. 1 illustrates an exemplary surgical training simulator 10. Surgical training simulator 10 may include a body form apparatus 20 which may comprise a body form 22. Body form 22 may be substantially hollow and may be constructed of plastic, rubber, or other suitable material. For support and to further replicate surgical conditions, body form 22 may rest upon a table 24. Body panel 26 overlays a section of body form 22 and may be made of a flexible material that simulates skin. Body panel 26 may include one or more apertures 28 for reception of one or more surgical implements during a training procedure, such as instruments 32. In particular, instruments 32 may, for example, be laparoscopic scissors, dissectors, graspers, probes, or other instruments, including a laparoscope, for which training is desired, and one or more instruments 32 may be the same instruments used in an actual surgical procedure. Various components of surgical training simulator 10 may be connected, directly or indirectly, to a computer 36 that receives data produced during training and processes that data. Specifically, computer 36 may include software programs with algorithms for calculating the location of surgical implements within body form 22 to assess the skill of the surgical trainee. Surgical training simulator 10 may include a monitor 38 operatively coupled to computer 36 for displaying training results, real images, graphics, training parameters, or a combination thereof, in a manner that a trainee can view both to perform the training and assess proficiency. The trainee may directly control computer 36, and thus, the display of monitor 38. Optionally, a foot pedal 30 may permit control of computer 36 in a manner similar to that of a computer mouse, thus freeing up the trainee's hands for the surgical simulation.

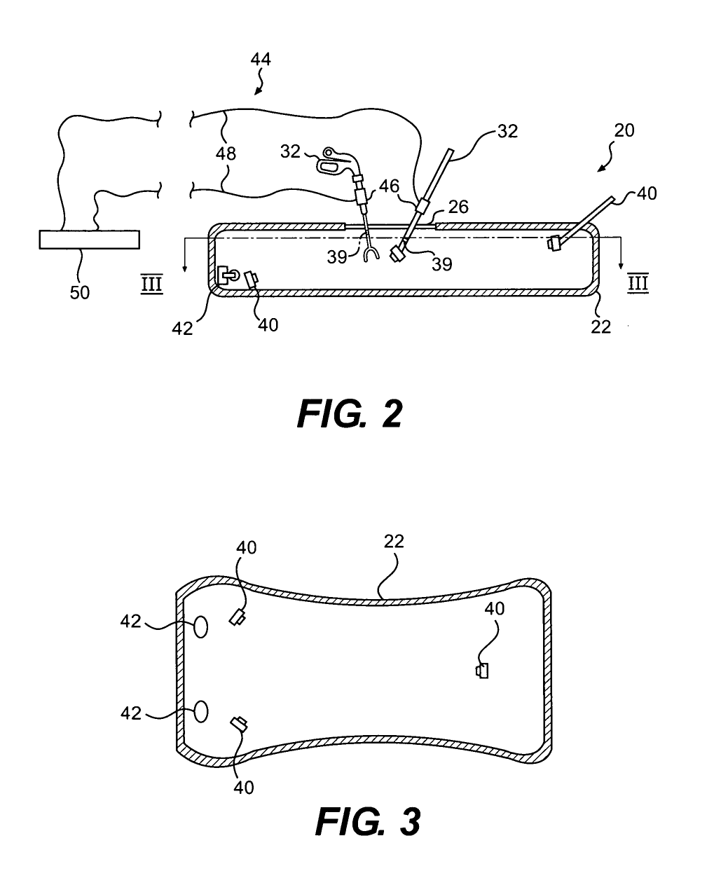

As shown in FIGS. 2 and 3, body form 22 includes a plurality of cameras 40. Cameras 40 may be fixed, although one or more may, with the aid of a handle or similar structure, be translationally and/or rotationally movable within body form 22. Both the position and number of cameras 40 within body form 22 may differ from the arrangement shown in FIGS. 2 and 3. Also located within body form 22 may be one or more light sources 42. Light sources 42 are preferably fluorescent and operate at a significantly higher frequency than the image acquisition frequency of cameras 40, thereby preventing strobing or other effects that may degrade the quality and consistency of those images obtained. As shown in the embodiment of FIG. 3, three cameras 40 are situated within body form 22 to capture visual images of one or more instrument 32 when the instruments are inserted through body panel 26. Cameras 40 are in communication with computer 36 and provide the visual images for a calculation in computer 36 of the six degrees of freedom (position (x,y,z) and alignment (pitch, roll, yaw)) of instruments 32 in a Cartesian coordinate system. Instruments 32 may be marked with one or more rings or other markings 39 at known positions to facilitate this calculation, as described below.

Referring again to FIG. 2, surgical training simulator 10 may also include a magnetic tracking system 44. In a present embodiment, magnetic tracking system 44 may consist of sensors 46 affixed to instruments 32. Attachment may be by various means, such as the use of adhesives, Velcro®, tying, or any other method reasonable to secure sensors 46 to instruments 32. It is contemplated that sensors 46 may be attached in a manner that does not constrain instruments 32 such that the use of the instruments during a training exercise approximates that of a live surgical procedure. Sensors 46 may be connected through connectors 48 to magnetic source module 50. It is also contemplated that magnetic tracking system 44 may be a wireless system, in that a physical connection is not required between sensors 46 and magnetic source module 50. Magnetic source module 50 may generate both three dimensional position and alignment data, as previously described, for instruments 32 and may transmit those signals to a host computer, such as computer 36, or other third party device. Magnetic tracking system 44 is commercially available with differing permutations of structural components and will not be further described.

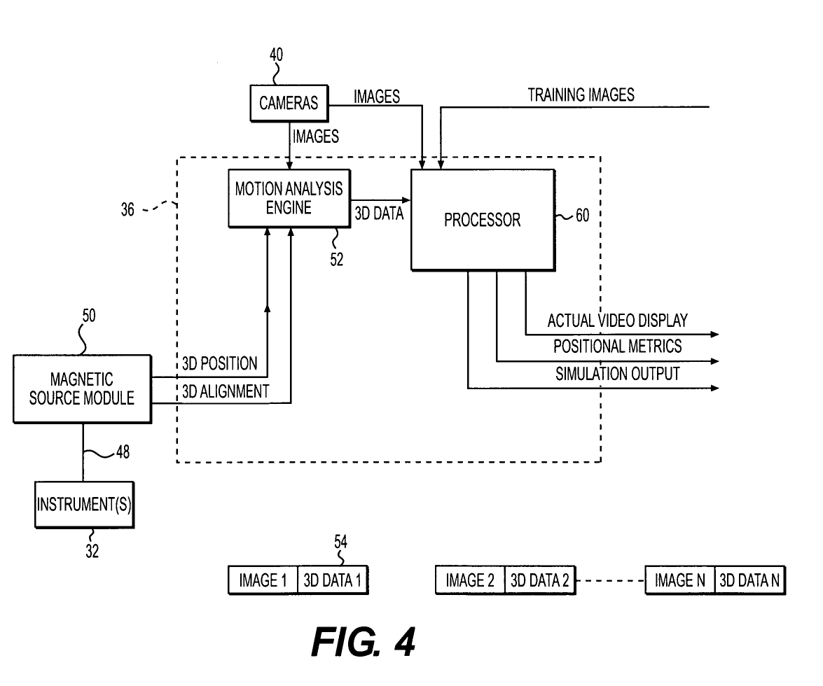

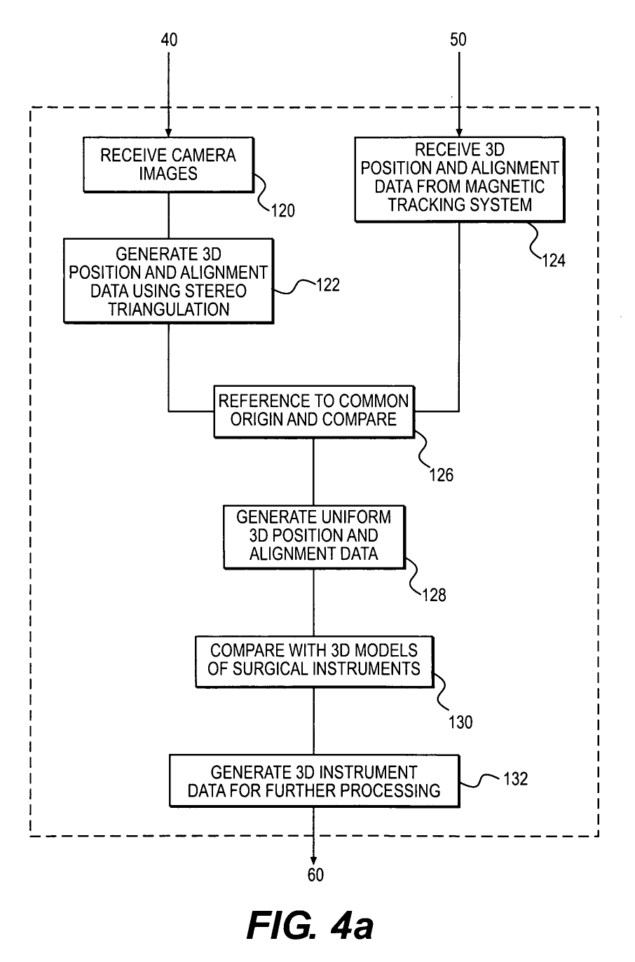

Referring to FIGS. 4 and 4a, in the embodiment shown, motion analysis engine 52 receives images of instruments 32 from cameras 40, further shown as step 120 in FIG. 4a. Engine 52 subsequently computes position and alignment data through the use of stereo triangulation, step 122. Stereo triangulation techniques for optical tracking are well known in the art and will not be further described. In step 124, motion analysis engine 52 receives three dimensional position and alignment data of instruments 32 from magnetic source module 50. The three dimensional position and alignment data from magnetic source module 50 may be referenced to the coordinate system of the optical tracking system prior to transmission to motion analysis engine 52. Within motion analysis engine 52 and step 126 of FIG. 4a, the position and alignment data generated from the stereo triangulation technique may be compared with the position and alignment data received from magnetic source module 50. If not previously realized, this comparison may initially include referencing the two sets of data to a common coordinate origin. The two sets of data may then, for example, be averaged to create a single set of resultant data for instruments 32. In another example, the two sets of data may be compared for the presence of anomalous trends, wherein the anomalous data is excised, again producing a set of resultant data for instruments 32. In addition, one or more sets of data received may be discarded for one or more predetermined reasons. Many other possibilities for comparing the two data sets in order to produce a single, uniform data set, step 128, are possible.

In step 130, this uniform position and alignment data is then compared with three dimensional models of instruments 32 stored in computer 36. In step 132, this comparison results in the generation of a set of 3D instrument data for use in further processing within processing function 60. The output of motion analysis engine 52 may comprise 3D data fields with six degrees of freedom linked effectively as packets 54 with associated images from cameras 40, as shown in FIG. 4. Cameras 40 also provide images directly to processing function 60, which may also receive training images and stored graphical templates. Outputs of processing function 60 may include actual video, positioning metrics, and/or a simulation output, displayed in various combinations on monitor 38.

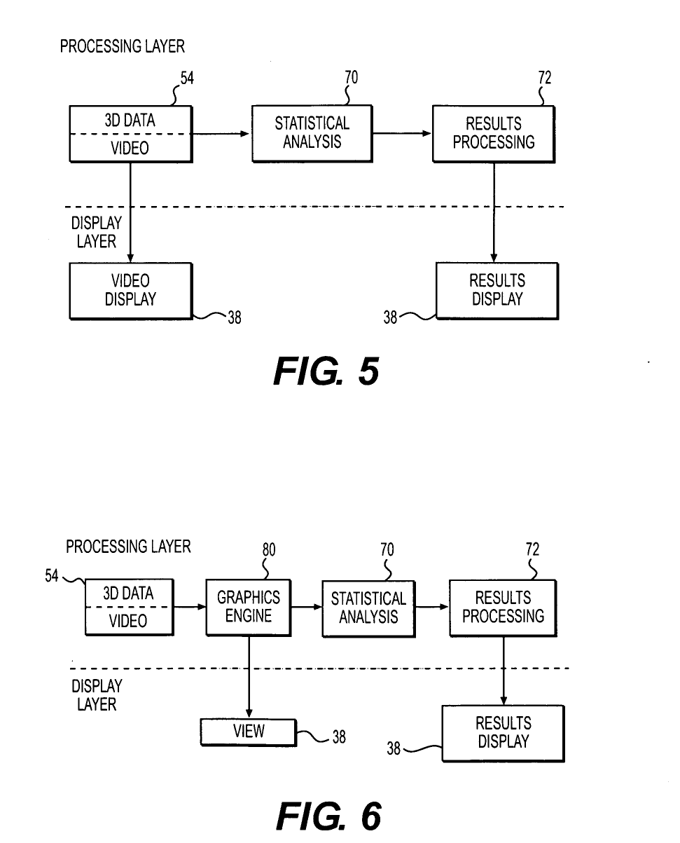

Referring to FIG. 5, in one mode of operation, the trainee manipulates instruments 32 within body form 22 during a surgical training exercise. As described above, cameras 40 may provide a live video image of instruments 32 for viewing on monitor 38. The 3D data generated by motion analysis engine 52 is fed to a statistical analysis engine 70, which extracts a number of measures based on the tracked position of instruments 32. A results processing function 72 compares these measures to a previously input set of criteria and generates a set of metrics that score the trainee's performance based on that comparison. Score criteria may be based on time, instrument path length, smoothness of movement, or other parameters indicative of performance. Monitor 38 may display this score alone or in combination with real images produced by cameras 40.

Referring to FIG. 6, in another mode of operation, the 3D data may be fed into a graphics engine 80, which renders simulated instruments on display monitor 38 based on the position of actual instruments 32. As the instrument or instruments 32 are moved within body form 22, the tracking data is continuously updated, changing the position of the rendered instruments to match that of instruments 32. Graphics engine 80 also includes the parameters necessary to render a virtual reality simulation of organs within body form 22. Alternatively, graphics engine 80 may render an abstract scene containing various other objects to be manipulated. The rendered organs or other objects may have space, shape, lighting, and texture attributes such that upon insertion of instruments 32. For example, graphics engine 80 may distort the surface of a rendered organ if the position of the simulated instrument enters the space occupied by the rendered organ. Within the virtual reality simulation, the rendered models of instruments 32 may then interact with the rendered elements of the simulation to perform various surgical tasks to comport with training requirements. Initially, a scene manager of graphics engine 80 by default renders a static scene of static rendered organs on monitor 38 viewed from the position of one of cameras 40. In this mode of operation, the trainee sees this virtual simulation on monitor 38 as the illusion that rendered instruments are interacting with the simulated organs within body form 22. In a similar fashion as above, graphics engine 80 feeds the 3D data into statistical analysis engine 70, which in turn feeds into results processing function 72 for comparison to predetermined criteria and subsequent scoring of performance.

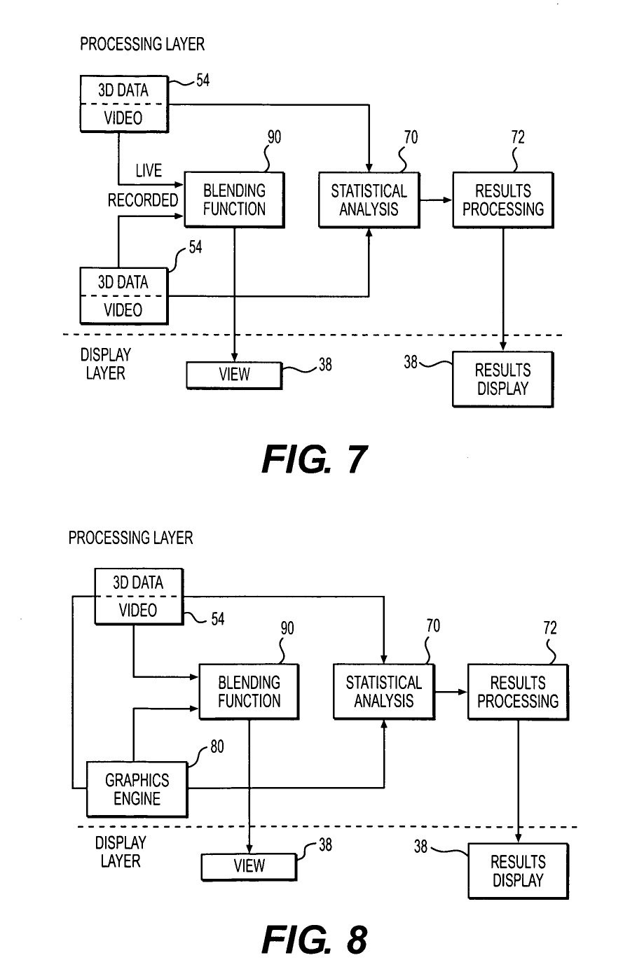

Referring to FIG. 7, in another mode of operation, a blending function 90 within processing function 60 receives live video images in the form of packets 54. Blending function 90 then combines these images with a recorded video training stream. Blending function 90 composites the images according to predetermined parameters governing image overlay and background/foreground proportions or, alternatively, may display the live and recorded images side-by-side. The 3D data is fed into statistical analysis engine 70, which in turn feeds into results processing function 72 for comparison to predetermined criteria and subsequent scoring of performance. By blending the trainee's movements with those predetermined by a trainer, training value is achieved through direct and immediate comparison of the trainee (live video stream) with a skilled practitioner (recorded video training stream).

In the mode of operation of FIG. 8, the 3D data is fed into graphics engine 80, which in turn feeds simulated elements to blending function 90. These simulated elements are blended with the video data from one of cameras 40 to produce a composite video stream, i.e., augmented reality, consisting of a view of live instruments 32 with virtual organs and elements. Specifically, graphics engine 80 may render a virtual image of the body cavity from the perspective of one of cameras 40. This virtual image may then be combined with the live image of instruments 32 to produce a detailed augmented reality simulation. The 3D data is also delivered to the statistical analysis engine 70 for processing, as previously described in other modes of operation.

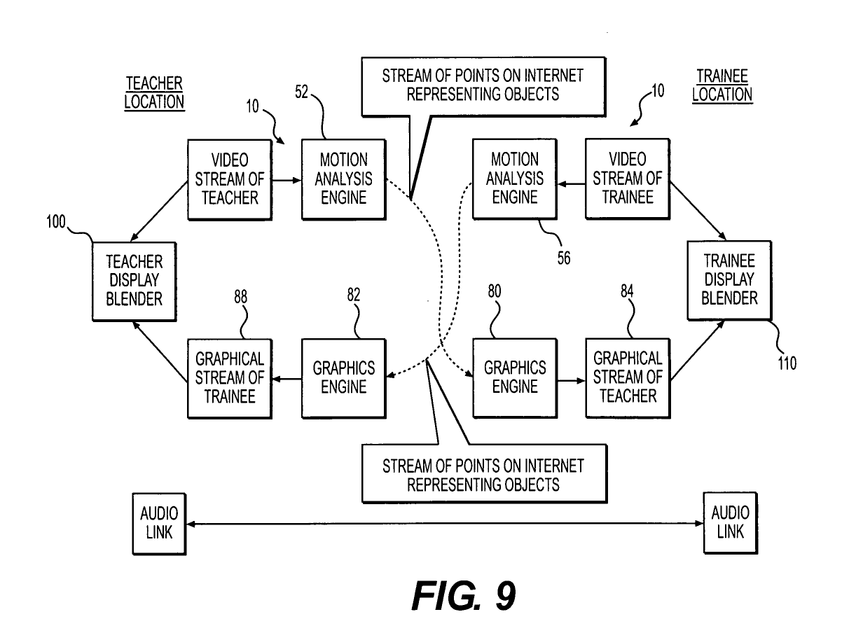

Referring to FIG. 9, the mode of operation presented allows for real-time training though the trainee and skilled practitioner may not be in close proximity. In this mode of operation, a surgical training simulator 10 exists at each of a remote teacher and trainee location. At the teacher location the video stream of the teacher, in the form of packets 54, is transmitted to motion analysis engine 52 and to teacher display blender 100. Motion analysis engine 52 at the teacher location may transmit over the internet a low-bandwidth stream comprising position and alignment data of one or more instruments 32 used by the teacher. Graphics engine 80 at the trainee location receives this position and alignment data and constructs graphical representations 84 of the teacher's instruments 32 and any other objects used by the teacher in the training exercise. Using trainee display blender 110, this virtual simulation of the teacher's instruments is blended at the trainee location with the video stream of the trainee. This video is also transmitted to a motion analysis engine 56 at the trainee location. Motion analysis engine 56 at the trainee location transmits a low-bandwidth stream across the internet to graphics engine 82 at the teacher location, which then constructs graphical representations 88 of the trainee's instruments. This virtual simulation of the trainee's instruments is blended with the video stream of the teacher at teacher display blender 100. The combined position and alignment data transmitted over the internet requires significantly less bandwidth than the transmission of video streams. As shown, this training may be supplemented with audio transmission, also over a low bandwidth link.

In all modes of operation described, computer 36 may display in monitor 38 a real-time training exercise or components of a training exercise previously performed and recorded, or various combinations thereof.

In one or more of these described modes of operation, actual objects may be inserted in body form 22. Such objects may be utilized to provide haptic feedback upon contact of an object with instruments 32. The inserted objects may also be used as part of the surgical training procedure, in which, for example, an object may be moved within body form 22 or an incision, suture, or other procedure may be performed directly on or to an inserted object.

It will be apparent to those skilled in the art that various modifications and variations can be made to the disclosed system for simulating a surgical procedure. Other embodiments will be apparent to those skilled in the art from consideration of the specification and practice of the disclosed method and apparatus. It is intended that the specification and examples be considered as exemplary only, with a true scope being indicated by the following claims and their equivalents.

What is claimed is:

1. A surgical training device, comprising:
a body form;
at least two cameras configured to obtain image data of at least one implement located within the body form;
a magnetic tracking system operative to transmit signals, the signals corresponding to position and alignment information of the at least one implement;
a computer configured to receive the image data from the at least two cameras, receive the signals from the magnetic tracking system, and generate from the image data and the signals position and alignment data of the at least one implement; and
a display operatively coupled to the computer and operative to display at least one image of the at least one implement and a virtual background, the virtual background depicting a portion of a body cavity.

2. The surgical training device of claim 1, wherein the at least one image of the at least one implement is a virtual image, the image of the at least one implement being based on the generated position and alignment data of the at least one implement.

3. The surgical training device of claim 1, wherein the at least one image of the at least one implement is a live video image.

4. The surgical training device of claim 1, wherein the computer is configured to compare the position and alignment data of the at least one implement with at least one digitally stored model of an implement.

5. The surgical training device of claim 1, wherein the computer is configured to compare position and alignment data from the image data with position and alignment data from the magnetic tracking system.

6. The surgical training device of claim 1, wherein the computer is configured to generate one or more performance metrics.

7. The surgical training device of claim 7, wherein the display is operative to display the one or more performance metrics with the at least one image of the at least one implement.

8. The surgical training device of claim 1, wherein the display is operative to display a recorded image of one or more surgical instruments with the at least one image of the at least one implement.

9. The surgical training device of claim 1, wherein the computer is configured to receive a digital stream comprising position and alignment data of one or more instruments from a second body form.

10. A method of surgical training, comprising:
optically tracking at least one implement located within a body form;
magnetically tracking the at least one implement;
generating position and alignment data of the at least one implement from the optical tracking and the magnetic tracking; and
displaying at least one image of the at least one implement and a virtual background, the virtual background depicting a portion of a body cavity.

11. The method of claim 10, wherein displaying at least one image of the at least one implement includes displaying a virtual image, the image of the at least one implement being based on the generated position and alignment data of the at least one implement.

12. The method of claim 10, wherein displaying at least one image of the at least one implement includes displaying a live video image.

13. The method of claim 10, further including: comparing the position and alignment data of the at least one implement with at least one digitally stored model of an implement.

14. The method of claim 10, further including: comparing position and alignment data from the optical tracking with position and alignment data from the magnetic tracking.

15. The method of claim 10, further including: generating one or more performance metrics.

16. The method of claim 15, further including: displaying the one or more performance metrics with the at least one image of the at least one implement.

17. The method of claim 10, further including: displaying a recorded image of one or more surgical instruments with the at least one image of the at least one implement.

18. The method of claim 10, further including: receiving a digital stream comprising position and alignment data of one or more instruments from a second body form.

19. A method of surgical training, comprising:
optically tracking at least one implement located within a body form;
generating a first set of position and alignment data of the at least one implement using stereo triangulation techniques;
magnetically tracking the at least one implement, the magnetic tracking generating a second set of position and alignment data of the at least one implement;
comparing the first set of position and alignment data with the second set of position and alignment data and generating a third set of position and alignment data;
comparing the third set of position and alignment data with at least one digitally stored model of an implement;
generating a set of three dimensional data fields; and
displaying at least one image of the at least one implement and a virtual background, the virtual background depicting a portion of a body cavity.
